(19) United States
(12) Patent Application Publication
(10) Pub. No.: US 2021/0122610 A1
(43) Pub. Date: Apr. 29, 2021

(54) MAINTENANCE CONTROL PANEL AND ELEVATOR CONTROL SYSTEM FOR CONTROLLING DISPLACEMENT MOVEMENTS OF AN ELEVATOR CAR

(71) Applicant: Inventio AG, Hergiswil (CH)

(72) Inventors: Daniel Arnold, Seedorf (CH); David Frey, Luzern (CH); Martin Sager, Oberkirch LU (CH); Patrick Bürgisser, Meierskappel (CH)

(21) Appl. No.: 15/733,490

(22) PCT Filed: Jun. 13, 2019
(86) PCT No.: PCT/EP2019/065522

§ 371 Date: Aug. 11, 2020

(30) Foreign Application Priority Data
Jun. 27, 2018 (EP) 18180092.1

(51) Int. Cl. B66B 5/00; B66B 1/50; B66B 1/32; B66B 1/30; G01D 5/14

(52) U.S. Cl. CPC B66B 5/0087; B66B 1/50; G01D 5/145; B66B 1/32; B66B 1/30; B66B 5/0018

(57) ABSTRACT

A maintenance control panel connected to an elevator control system controls displacement movements of an elevator car through actuation of activation, downward direction button and upward direction buttons. Each button has an actuation element displaceable in an actuation direction to change from an unactuated to an actuated actuation state when displaced beyond an actuation position and outputs an actuation signal representing the actuation state. At least one of the buttons has a position sensor detecting a current position of the actuation element and outputs a position signal representing the detected position. The elevator control system responds to the position signal to control a power supply to a drive motor and thus a displacement speed of the car. A maintenance technician can control the displacement speed intuitively, depending on how hard the button with the position sensor is pressed, to avoid an abrupt start or braking of the car.

### FIELD

The present invention relates to a maintenance control panel and an elevator control system for controlling displacement movements of an elevator car, and to a correspondingly equipped elevator.

### BACKGROUND

In the context of, for example, maintenance of an elevator, it may be necessary for a technician to be able to displace an elevator car inside an elevator shaft while he is outside the elevator car, i.e., for example on a roof of the elevator car. For this purpose, a maintenance control panel can be provided outside the elevator car, by means of which the technician can directly instruct a control unit of the elevator to control a drive of the elevator in such a way that the elevator car is displaced in a desired direction.

In order to be able to meet high safety requirements, three buttons in the form of an activation button and two direction buttons, i.e., a downward direction button and an upward direction button, are typically provided on the maintenance control panel. The technician can use the downward direction button or the upward direction button to specify the direction in which the elevator car is to be displaced. In order for the control unit to actually displace the elevator car, the technician must also press the activation button simultaneously with one of the direction buttons for safety reasons.

The three buttons are conventionally designed as simple switching elements, which can only be switched back and forth between an unactuated and an actuated actuation state. A speed at which the elevator car is displaced when a direction button and the activation button are pressed is generally preset. If necessary, the preset speed can be changed, but only as long as the elevator car is not moving.

It has now been recognized that displacing the elevator car during a maintenance process can be difficult, time consuming and/or even dangerous.

There may be a need, inter alia, for a maintenance control panel, an elevator control system equipped with such a maintenance control panel and an elevator equipped with such an elevator control system, in which a method of the elevator car can be carried out easily, quickly and/or safely.

### SUMMARY

Such a need can be met with the subject matter according to the advantageous embodiments explained in the description below.

According to a first aspect of the invention, a maintenance control panel for controlling displacement movements of an elevator car is proposed, the maintenance control panel having at least three buttons comprising an activation button, a downward direction button and an upward direction button. Each of the buttons has an actuation element which can be displaced in an actuation direction and is configured to transition from an unactuated to an actuated actuation state when the actuation element is displaced beyond a respective actuation position and to output an actuation signal correlating with the respective actuation state. A position sensor monitoring the respective button is provided on at least one of the buttons, which is configured to detect a current position of the actuation element of the respective button and to output a position signal that correlates with the detected position.

According to a second aspect of the invention, an elevator control system for controlling displacement movements of an elevator car of an elevator system is proposed. The elevator control system comprises a control unit for controlling a power supply to a drive motor driving the elevator car and a maintenance control panel according to an embodiment of the first aspect of the invention.

According to a third aspect of the invention, an elevator system with an elevator control system according to an embodiment of the second aspect of the invention is proposed.

Possible features and advantages of embodiments of the invention may be considered, inter alia, and without limiting the invention, as being based on the ideas and findings described below.

As noted in the introduction, maintenance control panels are used in particular when servicing elevator systems, in order to enable a technician, who, for example, is on the roof of an elevator car, to actuate the elevator system to displace the elevator car within an elevator shaft. For this purpose, the maintenance control panel is arranged outside the elevator car, for example on the roof of the elevator car.

For safety reasons, the maintenance control panel is integrated in a safety chain, via which a control unit of the elevator system monitors conditions within the elevator system, so that the elevator car can only be displaced or activated when the elevator system is in a safe state in this regard. Locking states of car doors and landing doors are monitored within the safety chain, for example, so that the car can only be displaced during normal operation of the elevator system if all doors are closed.

In normal operation, the displacement of the elevator car is controlled by the control unit in response to car call signals which can be triggered, for example, by passengers by actuating a car control panel (COP—cabin operation panel) or a floor control panel (LOP—landing operation panel).

If the elevator system is placed in a maintenance mode, the displacement of the elevator car can instead be controlled via control signals which are transmitted by the technician by actuating the maintenance control panel. The integration of the maintenance control panel into the safety chain of the elevator system can be designed in such a way that it is ensured that the elevator car is only displaced when the technician intentionally operates two of the buttons provided on the maintenance control panel at the same time.

However, it has been observed that it is difficult for a technician to displace the elevator car in a desired manner, in particular quickly, precisely and with low risk, using conventional maintenance control panels which are equipped with simple buttons.

In particular, it was recognized that this may be due, among other things, to the fact that a speed at which the elevator car is displaced in a controlled manner by the maintenance control panel is generally fixed before the maintenance control panel is actuated. At most, the speed of displacement can be changed while the elevator car is still standing, but not during a journey that has already started. This can mean additional effort and work complexity for the technician using the maintenance control panel.

It has also been observed that when the elevator car is displaced under the control of the maintenance control panel, it tends to move abruptly or even jump, i.e., to briefly move beyond a target position and then fall back. It was recognized that this is probably due to the fact that with conventional maintenance control panels a power supply to a drive motor of the elevator car can only be switched between two states, i.e., ON or OFF. If the elevator car is moving at a significant speed, turning it OFF does not necessarily result in the elevator car stopping immediately. Instead, due to its inertia, the elevator car can move a little further despite the drive motor being switched off, and then subsequently fall back to a position at which the drive motor is switched off. Depending on the displacement speed, such jumps can be up to 0.5 m and represent an inconvenience or even a danger to the technician in the elevator car.

In order, inter alia, to remedy the identified deficits of conventional maintenance control panels, it is proposed to equip at least one of the buttons on the maintenance control panel with a position sensor. This position sensor should be able to recognize the position up to which the button is currently pressed down by the technician and then output a position signal that correlates with the detected position. This position signal can then be transmitted to the control unit of the elevator system, so that the control unit can control the displacement speed of the elevator car as a function of this position signal.

Depending on how far he presses the corresponding button down, the technician can thus control how quickly the elevator car is to be displaced. Furthermore, the technician can, for example by slowly releasing the corresponding button, cause the displacement speed to be successively reduced towards the end of a journey in order to prevent the elevator car from stopping abruptly or even jumping.

Some of the terms used in this application are explained in more detail below.

The maintenance control panel can be a device by means of which the elevator car can be displaced during a maintenance mode. For this purpose, the maintenance control panel can communicate directly with the control unit of the elevator system. In particular, actuation signals generated in the maintenance control panel can be forwarded to the control unit in order to inform the control unit that the elevator car is to be displaced and, if necessary, in which direction the elevator car is to be displaced. The maintenance control panel should be as simple as possible and easy to use. In particular, a structure of the maintenance control panel should preferably correspond to the structure that a technician is used to from conventional maintenance control panels. For this purpose, the maintenance control panel should have at least three buttons.

A button can be understood to mean an actuation element that is actuated by displacing an actuation element in an actuation direction, in particular by pressing a button, and automatically returns to an initial position after being released. A mechanical spring is usually used for this. The actuation element is usually to be displaced linearly, i.e., the actuation direction is usually straight. However, buttons are also conceivable in which the actuation element cannot be displaced linearly, but rather, for example, by a rotary movement. As soon as the actuation element is displaced beyond a certain actuation position, the button changes its actuation state. For example, the button can be either open or closed in the unactuated state, i.e., when the actuation element is in a rest position, i.e., an electrical connection between a button input and a button output can be open or closed. The switch can then close or open when changing to the actuated state. Depending on the current actuation state, the button can output an actuation signal that correlates with the actuation state. For example, the button can output a logical “0” in the closed state and a logical “1” in the open state. This can be done simply by opening or closing a circuit running through the button depending on the actuation state. As an alternative or in addition, a corresponding actuation signal can be generated in the button in a targeted manner and as a function of the actuation state. The actuation signal can then be routed to a signal output and from there transmitted, for example, to the control unit of the elevator system.

The three buttons on the maintenance control panel include an activation button, a downward direction button and an upward direction button. The activation button must always be actuated by the technician to authorize the elevator car to displace. At the same time, the technician must then press either the downward direction button or the upward direction button in order to signal the control unit in which direction the elevator car is to be displaced by an actuation signal generated thereby.

A position sensor is provided on at least one of the buttons. The current position of the actuation element can be detected by means of this position sensor. The position sensor can either cooperate directly with the actuation element or cooperate with another element that is provided on the button and has a clear spatial relationship to the actuation element.

The position sensor should be configured to be able to distinguish at least two of the possible positions of the actuation element along the actuation direction. The position sensor can preferably differentiate between several such possible positions or even continuously differentiate the positions of the actuation element along the actuation direction. As explained in more detail below with the aid of examples, the position sensor can be designed and arranged in different ways. The position sensor can then output a position signal representing the detected position of the actuation element to a signal output, from where it can be transmitted, for example, to the control unit of the elevator system. On the basis of this position signal, the control unit can then recognize how far the corresponding button has been actuated by the technician and can conclude from this how quickly the elevator car should be displaced. The further the actuation element has been displaced in the actuation direction, the faster the elevator car should typically be displaced. A dependence of the displacement speed to be effected on the position of the actuation element can be linear or, in certain cases, also non-linear.

According to one embodiment, the maintenance control panel also has at least three signal outputs. Each of the three signal outputs is suitably connected to one of the buttons. A first signal output is configured to output the actuation signal that correlates with the actuation state of the activation button and/or the position signal that may correlate with the current position of the actuation element of the activation button. A second signal output is configured to output the actuation signal correlating with the actuation state of the downward direction button and/or the position signal which possibly correlates with the current position of the actuation element of the downward direction button. A third signal output is configured to output the actuation signal correlating with the actuation state of the upward direction button and/or the position signal correlating with the current position of the actuation element of the upward direction button.

In other words, the maintenance control panel preferably has at least three signal outputs via which actuation signals and/or position signals can be output from one of the buttons. This makes it easy and safe to wire the buttons to the signal outputs of the maintenance control panel. In addition, wiring of the control panel to the control unit of the elevator system can be configured simply and safely. However, the components mentioned do not necessarily have to be hard-wired to one another. Provision can also be made for wireless transmission of signals to or from one of the signal outputs.

According to one embodiment, the maintenance control panel also has a safety chain signal input and a safety chain signal output.

The downward direction button and the upward direction button are interconnected in parallel in a direction button unit. The direction button unit and the activation button are connected in series between the safety chain signal input and the safety chain signal output.

In other words, safety chain signal inputs and outputs can be provided on the maintenance control panel separately from the above-mentioned signal outputs or optionally also coupled to these signal outputs. Via the safety chain signal input and the safety chain signal output, the maintenance control panel can be integrated into the safety chain, which is monitored by the control unit of the elevator system. The two direction buttons are connected in parallel and then connected in series with the activation button.

With such an interconnection it can be achieved that the circuit between the safety chain signal input and the safety chain signal output is closed only when both the activation button and one of the direction buttons are actuated simultaneously. By monitoring the safety chain, it can thus be ensured that the control unit only initiates or permits a displacement of the elevator car if the technician actuates the activation button and a direction button at the same time.

According to one embodiment, a position sensor is provided on each of the downward direction button and the upward direction button.

In other words, it may be advantageous to realize the possibility of being able to control the displacement speed of the elevator car via the maintenance control panel by providing a position sensor on both the downward direction button and the upward direction button, which can detect the current position of the actuation element of the respective direction button and output a corresponding position signal. In this case, the activation button can be designed without a position sensor. For example, the activation button can be particularly difficult to actuate in order to be able to ensure that the activation button is generally only actuated intentionally, i.e., not accidentally. With such a difficult activation button, however, it would be difficult for a technician to gradually adjust an actuation position, since he has to press the actuation element down, for example, with a relatively large amount of force. In this case, the two direction buttons can be designed as relatively easy-to-actuate buttons, in which the actuation element can be gradually displaced along the actuation direction with little force.

Conversely, it is also possible to only equip the activation button with a position sensor. In this case, the two direction buttons do not need to be equipped with a position sensor. A technician could then control the displacement speed of the elevator car by pressing one of the direction buttons and at the same time gradually pressing down the actuation element of the activation button. Here, for example, the activation button can be designed to run smoothly and the direction buttons to be difficult to move.

According to one embodiment, the position sensor can be configured to detect a current position of the actuation element of the respective button at least when this actuation element is actuated from a rest position beyond the actuation position.

In other words, the actuation element of a button can be actuated from a starting position referred to as the rest position to a maximum displacement position to be reached. In this way, the actuation element at some point passes the actuation position at which the button changes from its unactuated to its actuated state. It can now be advantageous to design the position sensor in such a way that it detects the current position of the actuation element, in particular in a region in which the actuation element has already passed the actuation position, i.e., in a region between the actuation position and the maximum displacement position. The control unit of the elevator system should only permit or enable the elevator car to be displaced at the earliest once the actuation position has been reached. Only when the actuation element of the corresponding button is displaced beyond the actuation position should a technician be able to control the speed at which the elevator car is to be displaced, depending on how far the actuation element is displaced further.

According to one embodiment, the position sensor can be configured to detect the current position of the actuation element of the respective button without contact.

Due to the possibility of such a contactless detection of the position of the actuation element, the button can be made robust and, for example, insensitive to external influences and/or dirt. Signs of wear can also be minimized.

In particular, according to one embodiment, the button to be monitored by the position sensor can have a magnetic element which is mechanically coupled to the actuation element in such a way that it is moved when the actuation element is displaced. In this case, the position sensor can comprise a Hall sensor in order to output the actuation signal as a function of a relative position between the magnetic element and the Hall sensor.

In other words, the position sensor can detect the current position of the actuation element of the button to be monitored by using a Hall sensor to detect changes in the magnetic field generated by the magnetic element mechanically coupled to the actuation element. Such changes are in particular a function of a relative position between the magnetic element and the Hall sensor. This enables a possibility of an accurate and robust measurement of the current position of the actuation element.

In one embodiment of the elevator control system according to the second aspect of the invention, the control unit can be electrically connected to the maintenance control panel via a safety chain signal input provided in the maintenance control panel and a safety chain signal output provided in the maintenance control panel in order to monitor a current switching state of the maintenance control panel and to interrupt the power supply to the drive motor if the activation button is in the unactuated state or the upward direction button and the downward direction button are both in the unactuated state. The control unit can in this case be electrically connected to the maintenance control panel via a first, second, third and fourth signal input provided in the maintenance control panel in order to monitor the actuation signals correlating with current actuation states of the activation button, the upward direction button and the downward direction button and the position signal of the maintenance control panel correlating with the detected position and to establish the power supply to the drive motor when the activation button is in the actuated actuation state and at least one of the upward direction button and the downward direction button is in the actuated actuation state and at the same time control a strength of the power supply depending on the position signal.

In other words, the control unit of the elevator system can be connected to the maintenance control panel during a maintenance mode in a manner that makes it possible to monitor the current switching status of the maintenance control panel as part of a safety chain to be monitored by the control unit. In this case, the safety chain is interrupted as soon as at least either the activation button or one of the two direction buttons is not actuated. In this case, due to the interrupted safety chain, a power supply to the drive motor of the elevator arrangement is interrupted, so that the elevator car cannot be displaced.

In addition, the control unit can be connected to the maintenance control panel in a manner that makes it possible to read the actuation and position signals from the maintenance control panel. On the basis of these actuation and position signals, the control unit can decide whether a power supply for the drive motor should be established. If the actuation signals indicate that the activation button and one of the direction buttons are actuated simultaneously, the power supply to the drive motor should be established. In this case, a strength of the power supply should be controlled depending on the position signal, i.e., depending on how far the button equipped with the position sensor is currently actuated, the drive motor should be supplied with more or less power.

According to one embodiment, the control unit can also be configured to control a brake on the elevator car. The control unit can be electrically connected to the maintenance control panel via the safety chain signal input and the safety chain signal output in order to monitor a current switching state of the maintenance control panel and to activate the brake on the elevator car when the activation button is in the unactuated state or the upward direction button and the downward direction button are both in the unactuated state.

In other words, the maintenance control panel can be monitored by the control unit as part of a safety chain and the control unit can activate the brake provided on the elevator car, for example an emergency brake, if, for example, it is detected during a maintenance mode that not both the activation button and one of the direction buttons are actuated but at least the activation button is not actuated or at least both direction buttons are not actuated at the same time. In addition to interrupting the power supply by activating the brake, the control unit can thus ensure that the elevator car is not displaced as long as this is not authorized by the maintenance control panel by simultaneously actuating the two buttons required for this.

According to a specific embodiment, an activation threshold position can be arranged between an actuation position and a maximum displacement position along an actuation path of a button. The control unit can then be configured to establish the power supply to the drive motor at the earliest when the position signal of the button equipped with the position sensor indicates that the actuation element of the button coming from the rest position was displaced beyond the activation threshold position.

In other words, an actuation path along which the actuation element can be displaced when actuated in the case of a button equipped with a position sensor can be divided into different segments. A first segment can range from the rest position to the actuation position, from which the button changes its actuation state. A second segment can range from the actuation position to the maximum displacement position to which the actuation element can be maximally displaced. Within this second segment, the activation threshold position can be assumed beyond the actuation position.

When the button is actuated, the actuation element first reaches the actuation position, which is indicated by the position signal correlating with this. If the button is then actuated further, i.e., a button is pressed deeper down, for example, the actuation element sooner or later reaches the activation threshold position, which in turn is indicated by the position signal correlating therewith.

Only when this activation threshold position is reached is the control unit to establish the power supply to the drive motor. Since the activation threshold position and the actuation position are spaced apart from one another along the actuation path of the button, it can be achieved in this way that the control unit no longer specifically interrupts the power supply to the drive motor from the point in time at which the actuation element reaches the actuation position, and in particular deactivates the brake on the car but that a power supply to the drive motor is actually only established when the button is actuated even more and the actuation element is thus displaced beyond the activation threshold position. In this way, controlled and suitable actuation of the maintenance control panel enables a targeted and gentle start of the elevator car.

According to a further embodiment, the control unit can be configured to activate the brake on the elevator car at the earliest when the position signal of the button equipped with the position sensor indicates that the actuation element of the button coming from the maximum displacement position was displaced beyond the activation threshold position.

While the embodiment explained above was aimed at a targeted start at the beginning of a displacement of the elevator car, in this further embodiment the stopping after a displacement of the elevator car can be influenced. If the actuation element of the button is successively released at the end of a displacement process, the power supply to the drive motor can be successively reduced in accordance with the changing position signal. Accordingly, the elevator car is being displaced increasingly slowly. When the activation threshold position is reached, the power supply can be completely reduced so that the elevator car comes to a standstill. Only after the actuation element of the button is then displaced back to the rest position beyond the activation threshold position, does the control unit activate the brake on the elevator car. In this way it can be achieved that the brake is not activated when the elevator car is still moving and thus causes a hard jolt on the elevator car.

It should be noted that some of the possible features and advantages of the invention are described herein with reference to different embodiments of the maintenance control panel and the elevator control system equipped therewith and/or the elevator system equipped therewith. A person skilled in the art recognizes that the features can be combined, transferred, adjusted, or replaced in a suitable manner in order to arrive at further embodiments of the invention.

Embodiments of the invention will be described in the following with reference to the accompanying drawings, although neither the drawings nor the description should be construed as limiting the invention.

### DESCRIPTION OF THE DRAWINGS

FIG. 1 shows an elevator system comprising a maintenance control panel according to an embodiment of the present invention.

FIG. 2 shows an elevator control system according to an embodiment of the present invention.

FIG. 3 is a plot over time of actuation element position, safety chain switching state and elevator car speed signals generated according to an embodiment of the present invention.

The figures are merely schematic and not true to scale. Like reference signs refer to like or equivalent features in the various figures.

### DETAILED DESCRIPTION

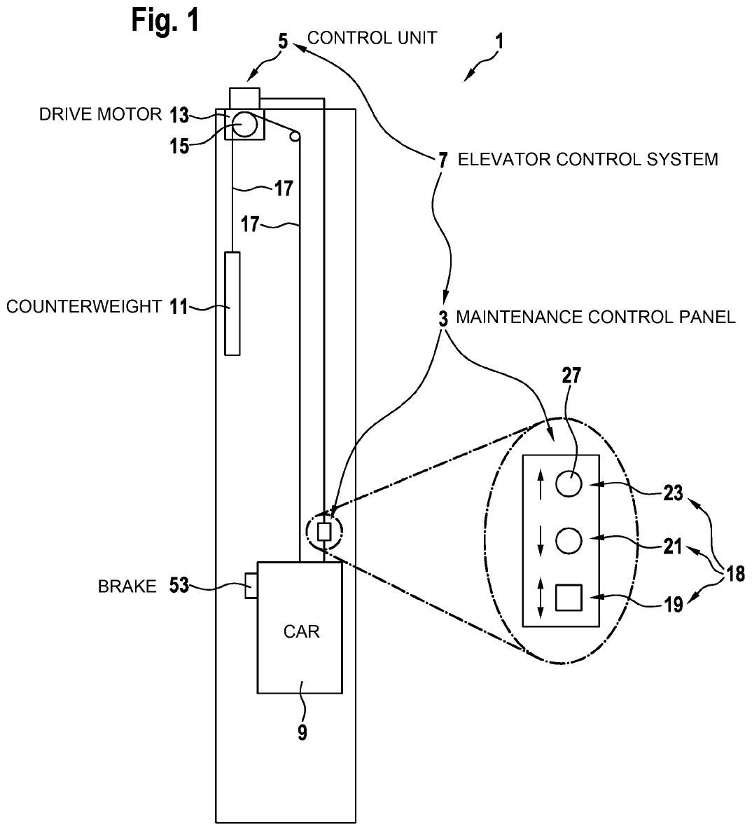

FIG. 1 illustrates an elevator system 1 according to one embodiment of the present invention. In the elevator system 1, an elevator car 9 and a counterweight 11, which are connected to one another via common suspension means 17, for example in the form of a plurality of belts, can be displaced with the aid of a traction sheave 15 driven by a drive motor 13. A power supply to the drive motor 13 is controlled by a control unit 5.

If the elevator system 1 is to be serviced and, for this purpose, is put into a maintenance mode, the elevator car 9 should be able to be displaced by a technician who is outside the elevator car 9 and is, for example, standing on a roof of the elevator car 9. For this purpose, a maintenance control panel 3 is provided at the corresponding point. The maintenance control panel 3 can communicate with the control unit 5 and, together with it, form an elevator control system 7, which can be used in particular during the maintenance mode to control displacement processes of the elevator system 1.

Three buttons 18 in the form of an activation button 19, a downward direction button 21 and an upward direction button 23 are provided on the maintenance control panel 3. Each of the buttons 18 can be temporarily actuated by pressing down an actuation element 27 and it subsequently automatically springs back into an unactuated state.

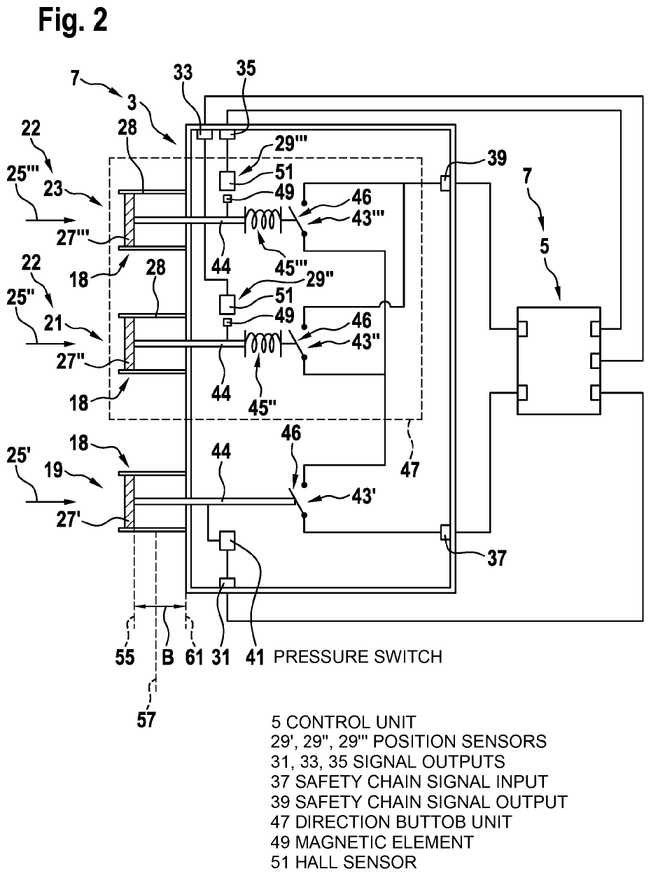

FIG. 2 schematically shows a detailed view of an embodiment of the elevator control system 7 with the maintenance control panel 3 and the control unit 5. Each of the buttons 18 has an actuation element 27 which can be displaced in a frame 28 in an actuation direction 25 (components of the activation button 19 are designated with an apostrophe (′), components of the downward direction button 21 with two apostrophes (″) and components of the upward direction button 23 subsequently with three apostrophes (′″)).

The actuation element 27 can be displaced starting from a rest position 55 along an actuation path B via an actuation position 57 up to a maximum displacement position 61. If the actuation element 27 is displaced beyond the actuation position 57, the respective button 18 changes from its unactuated state to an actuated state. This can be done, for example, by opening or closing a mechanical or electronic switch, hereinafter referred to as safety chain switch 43. An actuation signal representing the actuation state is generated.

The actuation element 27 can be rigidly coupled to a part 46 of the safety chain switch 43 to be actuated, for example via a rod 44 running between these components, so that the movement of the actuation element 27 is transmitted directly to the part 46 of the safety chain switch 43 to be actuated. Such a rigid coupling for the activation button 19 is shown in the depicted example.

Alternatively, the actuation element 27 can be coupled to the part 46 of the safety chain switch 43 to be actuated, for example via a spring element 45. In this case, for example, the actuation element 27 can be displaced up to the actuation position 57 and in doing so move the part 46 of the safety chain switch 43 to be actuated into an actuated state (i.e., in the example shown up to the closed state). Subsequently, the actuation element 27 can be displaced even further towards the maximum displacement position 61, wherein only the spring element 45 is deformed, but the part 46 of the safety chain switch 43 to be actuated is displaced no further and the switching state of the safety chain switch 43 is thus not changing.

A position sensor 29 is provided at least on one of the buttons 18. In the example shown, position sensors 29″, 29′″ are provided on the downward direction button 21 and on the upward direction button 23. These position sensors 29″, 29′″ are designed to detect a current position of the respective actuation element 27″, 27′″ of the respective button 18 assigned thereto and to subsequently output a position signal that correlates with the detected position.

In the example shown, the position sensors 29 are designed as Hall sensors 51. Magnetic elements 49 are provided on the buttons 18. The magnetic elements 49 are preferably rigidly coupled to the respective actuation element 27, so that when the actuation element 27 is displaced, the respective magnetic element 49 is displaced in a corresponding manner. Such a displacement of the magnetic element 49 and the associated change in the relative position between the magnetic element 49 and the respective Hall sensor 51 is accompanied by a change in a magnetic field generated by the magnetic element 49 in the region of the Hall sensor 51. By measuring such a change in the magnetic field, the Hall sensor 51 can generate the position signal correlating with the position of the actuation element 27.

However, other configurations of a position sensor 29 can also be used. For example, the position of the actuation element 27 can be detected mechanically, optically, capacitively, inductively or in some other way.

Three signal outputs 31, 33, 35 are provided on the maintenance control panel 3. In the example shown, a third signal output 35 is connected to the position sensor 29′″ of the upward direction button 23 and a second signal output 33 is connected to the position sensor 29″ of the downward direction button 21. A first signal output 31 is connected to a pressure switch 41, which is actuated when the actuation element 27′ of the activation button 19 is actuated.

Accordingly, at each of the three signal outputs 31, 33, 35 the position signal detected at the assigned button 18 and/or the actuation signal generated at the assigned button 18 can be output. The position signal can be generated by one of the position sensors 29. The actuation signal can be generated by another sensor, for example the pressure switch 41. Alternatively, the actuation signal can also be derived by analyzing a position signal generated by one of the position sensors 29. As a further alternative, the actuation signal can also be derived by analyzing the switching state prevailing on the assigned safety chain switch 43.

The three signal outputs 31, 33, 35 of the maintenance control panel 3 are connected to the control unit 5. Accordingly, the actuation signals and position signals can be transmitted to the control unit 5. As an alternative to data transmission via hard-wired connections, wireless signal transmission can be conceivable. On the basis of the actuation signals and position signals, the control unit 5 can then control a power supply to the drive motor 13 of the elevator system 1 and, if appropriate, a brake 53 on the elevator car 9. In particular, as described by way of example below, a displacement speed with which the elevator car 9 is to be displaced can be controlled taking into account the position signals transmitted by the maintenance control panel 3.

A safety chain signal input 37 and a safety chain signal output 39 are also provided on the maintenance control panel 3. The maintenance control panel 3 is also connected to the control unit 5 via the safety chain signal input 37 and the safety chain signal output 39, so that the control unit 5 can monitor a safety-relevant state of the maintenance control panel 3 as part of a safety chain.

Within the maintenance control panel 3, the downward direction button 21 and the upward direction button 23 with their respective safety chain switches 43″, 43′″ are connected in parallel with one another and can be regarded as combined in a direction button unit 47. The direction button unit 47 is connected in series with the activation button 19 and its safety chain switch 43′.

Through this series connection, the control unit 5 can use the safety chain signal input 37 and the safety chain signal output 39 to recognize whether the activation button 19 and/or both the downward direction button 21 and the upward direction button 23 are both open at the same time and thus the series connection within the maintenance control panel 3 is interrupted. In the event of an interruption in the safety chain, the control unit 5 can interrupt a power supply to the drive motor 13 of the elevator system 1 and/or activate a brake 53 provided on the elevator car 9. Only when both the activation button 19 and at least one of the direction buttons 22 in the direction button unit 47 are actuated at the same time is the series connection in the safety chain closed and the control unit 5 can establish a power supply to the drive motor 13 and/or release the brake 53.

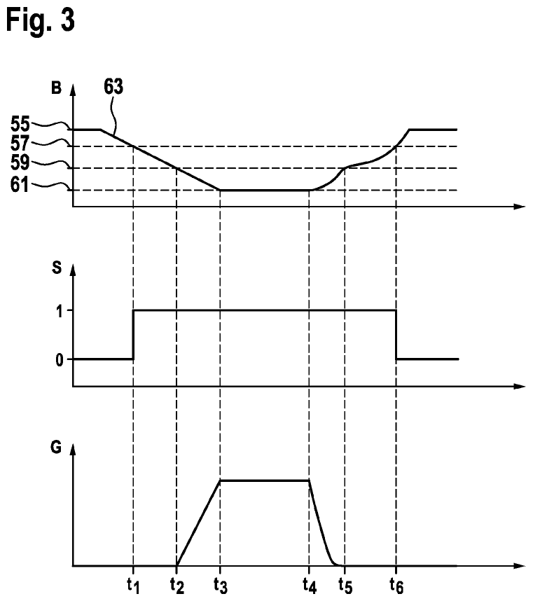

Below, with reference to FIG. 3, it is described by way of example how a technician can control a displacement process of the elevator system 1 during maintenance using the maintenance control panel 3. FIG. 3 illustrates how a position signal 63 changes when the actuation element 27 of a button 18 equipped with a position sensor 29 is actuated along an actuation path “B” from the rest position 55 via the actuation position 57 and an activation threshold position 59 until it reaches the maximum displacement position 61 and is subsequently released until it reaches the rest position 55. FIG. 3 also illustrates how a switching state “S” of a safety chain between the safety chain signal input 37 and the safety chain signal output 39 changes depending on the varying position signal 63 between an open state “0” and a closed state “1.” FIG. 3 also shows how the speed “G” of the elevator car 9 changes while the elevator car 9 is being displaced in a manner controlled by the control unit 5 taking into account the position signal 63.

Initially, the actuation element 27 of the button 18 is displaced from the rest position 55 to the actuation position 57. Neither the switching state S of the safety chain, i.e., MS=0, nor the speed G of the elevator car, i.e., G=0, changes. Only when the actuation element 27 is displaced beyond the actuation position 57 at time t₁, provided the activation button 19 is pressed at the same time, is the safety chain closed, i.e., S=1. At this time, however, a power supply to the drive motor 13 is not yet activated, i.e., G=0. Only when the actuation element 27 is pressed further in the direction of the maximum displacement position 61 and reaches the activation threshold position 59 at a time t₂ does the control unit 5 recognize this on the basis of the correspondingly detected position signal 63 and begin to supply the drive motor 13 with electrical power and consequently to set the elevator car 9 in motion, i.e., G>0. The further the actuation element 27 is pressed in the direction of the maximum displacement position 61, the faster the elevator car 9 is displaced until a desired maximum speed is reached at time t₃ G>>0.

In order to brake and finally stop the elevator car 9, the technician gradually releases the pressure on the actuation element 27 from a time t₄ onwards. This can be done deliberately and gently, so that near a point in time t₅, when the elevator car has already become very slow, since the actuation element 27 is approaching the activation threshold position 59, the actuation element 27 is only slowly released towards the activation threshold position 59. An abrupt stopping of the elevator car 9 can thereby be prevented and the elevator car 9 can come to a gentle stop, i.e., G=0. In particular, at this time t₅, a power supply to the drive motor 13 is not yet interrupted and the brake 53 on the elevator car 9 is also not yet activated. This only happens when the actuation element 27 reaches the actuation position 57 at a time t₆ and is displaced further to the rest position 55, since in this case the safety chain is opened again, i.e., S=0.

In summary and with another choice of words, it is proposed according to embodiments of the present invention to provide an additional switch in the form of a position sensor in the maintenance control panel. This additional switch can be wired parallel to the direction buttons and work pressure-sensitive. The harder a user presses the direction button down, the higher the position signal generated by it. The control unit adjusts the inspection speed of the elevator car in accordance with this position signal. The more the user presses the direction button, the faster the elevator car moves. In this way, the technician can control the car speed directly and in a very intuitive manner and in particular without interruptions. It is therefore possible to displace the car to a desired position quickly and safely. In particular, it is possible on the basis of the position signal supplied by the position sensor relating to the direction buttons to stop the elevator car before the safety chain opens. An abrupt stopping or even jumping of the elevator car can thereby be avoided.

Finally, it should be noted that terms such as “having,” “comprising,” etc. do not preclude other elements or steps and terms such as “a” or “an” do not preclude a plurality. Furthermore, it should be noted that features or steps that have been described with reference to one of the above embodiments can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SIGNS

1 elevator system
3 maintenance control panel
5 control unit
7 elevator control system
9 elevator car
11 counterweight
13 drive motor
15 traction sheave
17 suspension means
18 button
19 activation button
21 downward direction button
22 direction button
23 upward direction button
25 actuation direction
27 actuation element
28 frame
29 position sensor
31 first signal output
33 second signal output
35 third signal output
37 safety chain signal input
39 safety chain signal output
41 pressure switch
43 safety chain switch
44 rod
45 spring element
46 part of the safety chain switch to be actuated
47 direction button unit
49 magnetic element
51 Hall sensor
53 brake
55 rest position
57 actuation position
59 activation threshold position
61 maximum displacement position
63 position signal
B actuation path
G elevator car speed
S safety chain switching state

1-13. (canceled)

14. A maintenance control panel for controlling displacement movements of an elevator car, the maintenance control panel comprising:
an activation button, a downward direction button and an upward direction button;
each of the buttons including an actuation element displaceable in an actuation direction and which, when the actuation element is displaced beyond a respective actuation position, changes from an unactuated actuation state to an actuated actuation state and outputs an actuation signal representing the actuated actuation state; and
wherein at least one of the buttons includes a position sensor monitoring the displacement of the at least one button by detecting a current position of the actuation element of the at least one button and outputting a position signal representing the detected current position.

15. The maintenance control panel according to claim 14 further comprising:
a first signal output for outputting at least one of the actuation signal representing the actuation state of the activation button and, when the activation button includes the position sensor, the position signal representing the detected current position of the actuation element of the activation button;
a second signal output for outputting at least one of the actuation signal representing the actuation state of the downward direction button and, when the downward direction button includes the position sensor, the detected position signal representing the detected current position of the actuation element of the downward direction button; and
a third signal output for outputting at least one of the actuation signal representing the actuation state of the upward direction button and, when the upward direction button includes the position sensor, the detected position signal representing the detected current position of the actuation element of the upward direction button.

16. The maintenance control panel according to claim 14 including a safety chain signal input and a safety chain signal output, wherein the downward direction button and the upward direction button are connected in parallel in a direction button unit and the direction button unit and the activation button are connected in series between the safety chain signal input and the safety chain signal output.

17. The maintenance control panel according to claim 14 wherein each of the downward direction button and the upward direction button includes one of the position sensor.

18. The maintenance control panel according to claim 14 wherein the position sensor is adapted to detect the current position of the actuation element of the at least one button when the actuation element is actuated from a rest position to beyond the actuation position.

19. The maintenance control panel according to claim 14 wherein the position sensor is adapted to detect the current position of the actuation element of the at least one button contactlessly.

20. The maintenance control panel according to claim 14 wherein the at least one button monitored by the position sensor includes a magnetic element mechanically coupled to the actuation element for movement when the actuation element is displaced, and wherein the position sensor has a Hall sensor outputting the actuation signal as a function of a relative position between the magnetic element and the Hall sensor.

21. An elevator control system for controlling displacement movements of an elevator car of an elevator system comprising:
a control unit controlling a power supply to a drive motor driving the elevator car; and
the maintenance control panel according to claim 14 connected to the control unit for transmitting the actuation signals and the position signal to the control unit.

22. The elevator control system according to claim 21 further comprising:
wherein the control unit is electrically connected to the maintenance control panel via a safety chain signal input on the maintenance control panel and a safety chain signal output on the maintenance control panel to monitor a current switching state of the maintenance control panel and to interrupt the power supply to the drive motor when the activation button is in the unactuated state or the upward direction button and the downward direction button are both in the unactuated state; and
wherein the control unit is electrically connected to the maintenance control panel via first, second and third signal outputs on the maintenance control panel to monitor the actuation signals representing the current actuation states of the activation button, the upward direction button and the downward direction button, to monitor the position signal representing the detected position of the at least one button and to establish the power supply to the drive motor when the activation button is in the actuated actuation state and one of the upward direction button and the downward direction button is in the actuated actuation state and thereby control a strength of the power supply as a function of the position signal.

23. The elevator control system according to claim 22 wherein the control unit controls a brake on the elevator car and wherein the control unit activates the brake when the activation button is in the unactuated state or the upward direction button and the downward direction button are both in the unactuated state.

24. The elevator control according to claim 23 wherein an activation threshold position is arranged between the actuation position and a maximum displacement position along an activation path of the at least one button equipped with the position sensor, and wherein the control unit establishes the power supply to the drive motor no sooner than when the position signal of the at least one button indicates that the actuation element of the at least one button coming from the rest position was displaced beyond the activation threshold position in relation to the rest position.

25. The elevator control system according to claim 23 wherein the activation threshold position is arranged between the actuation position and a maximum displacement position along an activation path of the at least one button equipped with the position sensor, and wherein the control unit activates the brake on the elevator car no sooner than when the position signal of the at least one button indicates that the actuation element of the at least one button coming back from the maximum displacement position was displaced beyond the activation threshold position in relation to the maximum displacement position.

26. An elevator system comprising:
an elevator control system according to claim 21;
an elevator car;
a drive motor driving the elevator car;
a power supply connected to the drive motor; and
wherein the control unit and the maintenance control panel of the elevator control system cooperate to control displacement movements of the elevator car by controlling electrical power supplied to the drive motor by the power supply.
